(19) United States
(12) Patent Application Publication
(10) Pub. No.: US 2026/0261493 A1
(43) Pub. Date: Sep. 3, 2026

(54) Characterizing Quality of Experience (QoE) and Radio Access Network Visible QoE (RVQoE) Reports with Filtering Parameters

(71) Applicant: Telefonaktiebolaget LM Ericsson (publ), Stockholm (SE)

(72) Inventors: Luca Lunardi, Genova (IT); Filip Barac, Huddinge (SE); Johan Rune, Lidingö (SE); Cecilia Eklöf, Täby (SE); Vengatanathan Krishnamoorthi, Linköping (SE); Agne Åberg Larsson, Uppsala (SE)

(21) Appl. No.: 19/125,583

(22) PCT Filed: Nov. 1, 2023
(86) PCT No.: PCT/IB2023/061014

§ 371 Date: Apr. 29, 2025

Related U.S. Application Data
(60) Provisional application No. 63/422,383, filed on Nov. 3, 2022.

(51) Int. Cl. H04L 41/5067; H04W 24/10

(52) U.S. Cl. CPC H04L 41/5067; H04W 24/10

(57) ABSTRACT

A User Equipment (UE) (300) receives one or more filtering parameters for a Quality of Experience (QoE) measurement configuration and performs the QoE measurements according to at least one of the QoE measurement configuration and the one or more filtering parameters associated with the QoE measurement configuration. The UE then sends a QoE report and characterizing information associated with the QoE report to a Radio Access Network (RAN) node (400). The characterizing information is based on the one or more filtering parameters associated with the QoE measurement configuration.

### TECHNICAL FIELD

The present application relates generally to measurement reporting, and more particularly to methods and devices for enhanced QoE/RVQoE measurement reporting.

### BACKGROUND

Quality of Experience (QoE) measurements, also referred to as “application layer measurements,” have been specified for both Long Term Evolution (LTE) and Universal Mobile Telecommunications Service (UMTS) and are being specified for New Radio (NR) in Release 17 of the 3^{rd} Generation Partnership Project (3GPP) standards. The purpose of the application layer measurements is to measure the end user experience when using certain applications. Currently, QoE measurements for streaming services and for Mobility Telephony Service for Internet Protocol Multimedia Subsystem (MTSI) services are supported. For NR, it is likely that at least Virtual Reality (VR) is added to the list of services for which QoE measurements will be specified and supported.

### BRIEF DESCRIPTION OF THE DRAWINGS

FIG. 1 illustrates an architecture for a Next Generation (NG) Radio Access Network (RAN).

FIG. 2 illustrates an overall architecture for separation of gNB-CU-CP and gNB-CU-UP.

FIG. 3 illustrates the overall Evolved Universal Terrestrial Radio Access Network New Radio-Dual Connectivity (EN-DC) architecture.

FIG. 4 illustrates the overall Integrated Access and Backhaul (IAB) architecture.

FIG. 5 illustrates a method implemented by a User Equipment (UE) according to one embodiment of the present disclosure.

FIG. 6 illustrates an exemplary UE configured for measurement reporting according to one embodiment of the present disclosure.

FIG. 7 illustrates a method implemented by a network node according to one embodiment of the present disclosure.

FIG. 8 illustrates an exemplary network node configured for measurement reporting according to one embodiment of the present disclosure.

FIG. 9 shows the main functional components of a UE configured for measurement reporting according to one embodiment of the present disclosure.

FIG. 10 shows the main functional components of a network node configured for measurement reporting according to one embodiment of the present disclosure.

### SUMMARY

Embodiments of the present disclosure provide methods and corresponding apparatuses for enhanced QoE/RVQoE measurement reporting. In a first aspect, the present disclosure provides a method of measurement reporting implemented by a user equipment (UE). In this aspect, the method comprises the UE receiving one or more filtering parameters associated with a Quality of Experience (QoE) measurement configuration. Once received, the UE performing QoE measurements according to at least one of the QoE measurement configuration and the one or more filtering parameters associated with the QoE measurement configuration. The UE then sends, to a first radio access network (RAN) node, a QoE report including the QoE measurements and characterizing information associated with the QoE report. The characterizing information associated with the QoE report is based on the one or more filtering parameters associated with the QoE measurement configuration.

In a second aspect, the present disclosure provides a User Equipment (UE) configured for measurement reporting. In this aspect, the UE is configured to receive one or more filtering parameters associated with a Quality of Experience (QoE) measurement configuration. The UE is then configured to perform QoE measurements according to at least one of the QoE measurement configuration and the one or more filtering parameters associated with the QoE measurement configuration. So measured, the UE sends, to a first radio access network (RAN) node, a QoE report including the QoE measurements and characterizing information associated with the QoE report. The characterizing information is based on the one or more filtering parameters associated with the QoE measurement configuration.

In a third aspect, the present disclosure provides a User Equipment (UE) configured for measurement reporting. In this aspect, the UE comprises interface circuitry for communicating with a network node over a wireless communication channel and processing circuitry operatively connected to the interface circuitry. The processing circuitry in this aspect is configured to receive one or more filtering parameters associated with a Quality of Experience (QoE) measurement configuration and perform QoE measurements according to at least one of the QoE measurement configuration and the one or more filtering parameters associated with the QoE measurement configuration. The processing circuitry is also configured to send, to a first radio access network (RAN) node, a QoE report including the QoE measurements and characterizing information associated with the QoE report. The characterizing information is based on the one or more filtering parameters associated with the QoE measurement configuration.

In a fourth aspect, the present disclosure provides a computer program comprising executable instructions that, when executed by a processing circuitry in a User Equipment (UE) in a wireless communication network, causes the UE to perform the method of the first aspect.

In a fifth aspect, the present disclosure provides a non-transitory computer-readable storage medium containing a computer program comprising executable instructions that, when executed by processing circuitry in a User Equipment (UE) in a wireless communication network causes the UE to perform the method of the first aspect.

In a sixth aspect, the present disclosure provides a method of measurement reporting implemented by a network node. In this aspect, the method comprises the network node receiving a Quality of Experience (QoE) report from a User Equipment (UE). The QoE report comprises QoE measurements performed by the UE according to at least one of a QoE measurement configuration provided to the UE and one or more filtering parameters associated with the QoE measurement configuration provided to the UE. So received, the network node obtains information associated with the QoE report. The information is based on the one or more filtering parameters associated with the QoE measurement configuration.

In a seventh aspect, the present disclosure provides a network node in a wireless communication network configured for measurement reporting. In this aspect, the network node is configured to receive a Quality of Experience (QoE) report from a User Equipment (UE). The QoE report comprises QoE measurements performed by the UE according to at least one of a QoE measurement configuration provided to the UE and one or more filtering parameters associated with the QoE measurement configuration provided to the UE. The network node is then further configured to obtain information associated with the QoE report. The information is based on the one or more filtering parameters associated with the QoE measurement configuration.

In an eighth aspect, the present disclosure provides a network node in a wireless communication network configured for measurement reporting. In this aspect, the network node comprises interface circuitry and processing circuitry operatively connected to the interface circuitry. The interface circuitry is configured for communicating with other network nodes and/or User Equipment (UE). The processing circuitry is configured to receive a Quality of Experience (QoE) report from a User Equipment (UE). The QoE report comprises QoE measurements performed by the UE according to at least one of a QoE measurement configuration provided to the UE and one or more filtering parameters associated with the QoE measurement configuration provided to the UE. The processing circuitry is further configured to obtain information associated with the QoE report. The information is based on the one or more filtering parameters associated with the QoE measurement configuration.

In a ninth aspect, the present disclosure provides a computer program comprising executable instructions that, when executed by a processing circuitry in a network node in a wireless communication network, causes the network node to perform the method according to the sixth aspect.

In a ninth aspect, the present disclosure provides a non-transitory computer-readable storage medium containing a computer program comprising executable instructions that, when executed by a processing circuitry in a network node in a wireless communication network, causes the network node to perform the method according to the sixth aspect.

### DETAILED DESCRIPTION

Throughout this disclosure, various terms are used interchangeably. For example, the terms “UE”, “terminal equipment”, “wireless terminal” and “terminal” are used interchangeably, as are the terms “Filtering parameters”, “Filtering parameters to characterize Quality of Experience (QoE)/Radio Access Network (RAN) Visible (RVQoE) reports”, “Filtering parameters for characterizing QoE/RVQoE reports,” “filtering criteria,” and “criteria.”

The terms “application layer measurement configuration”, “application measurement configuration”, “RVQoE measurement configuration”, “RVQoE configuration”, “RVQoE measurement and reporting configuration” and “QMC configuration” are also used interchangeably. However, the “QMC configuration file” is not an equivalent term. Rather, this term instead refers to the part of the Secondary Node (SN) configuration consisting of an XML file containing instructions of SN metrics to be collected etc.

In the context of the present disclosure, a network node can be a RAN node, a gNB, an eNB, an en-gNB, a ng-eNB, a gNB-CU, a gNB-CU-CP, a gNB-CU-UP, an eNB-CU, an eNB-CU-CP, an eNB-CU-UP, an IAB-node, an IAB-donor DU, an IAB-donor-CU, an IAB-DU, an IAB-MT, an O-CU, an O-CU-CP, an O-CU-UP, an O-DU, an O-RU, an O-eNB, a Non-Real Time RAN Intelligent Controller (Non-RT RIC), a Real-Time RAN Intelligent Controller (RT-RIC), an OAM node, a Core Network node/function, a Cloud-based network function, and a Cloud-based centralized training node.

Further, all references to the application layer are with respect to the application layer of the UE (since RAN nodes do not have an application layer).

In this disclosure, the term “service” is often used as a short notation for “service type.” Therefore, the terms “service” and “service type” can be seen as being used interchangeably unless explicitly stated.

The present embodiments apply to both signaling-based and management-based RVQoE measurements. Optionally, however, they may also be restricted to apply to only signaling-based RVQoE measurements or management-based RVQoE measurements.

The terms “RVQoE report” and “RVQoE measurement report” and “report” are used interchangeably, as is the term “QoE.”

The terms “access stratum” and “radio layer” are used interchangeably when referring to a UE, and the term “session” refers to an application session for which RVQoE measurement is applied.

Further, the embodiments disclosed herein may also apply to Universal Mobile Telecommunication System (UMTS), Long Term Evolution (LTE) and NR, as well as future Radio Access Technologies (RATs) such as 6G.

It should be noted that while the present embodiments are described in context of example signaling-based RVQoE measurements, they are equally applicable to both management-based and signaling-based RVQoE measurements. Additionally, the embodiments disclosed herein are equally applicable to QoE and RVQoE.

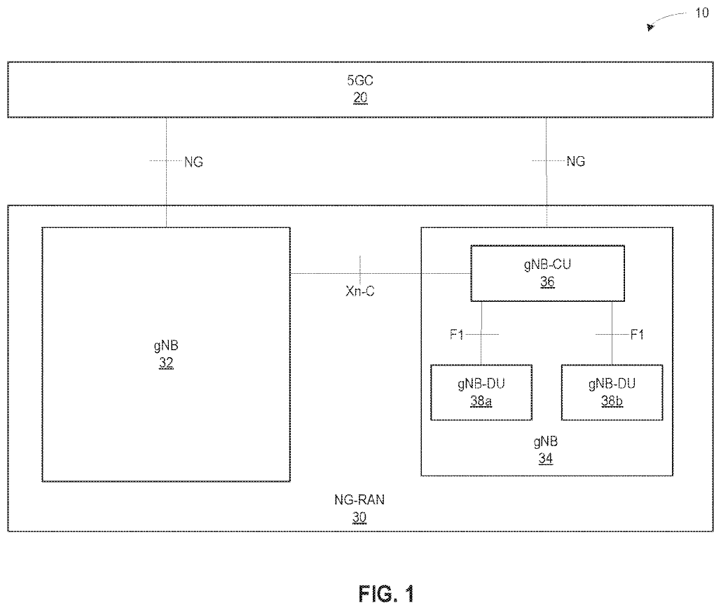

Turning now to the drawings, FIG. 1 illustrates an architecture 10 for a Next Generation (NG) Radio Access Network (RAN) 30. As seen in FIG. 1, the NG-RAN 30 comprises of a set of gNodeBs (gNBs) 32, 34 connected to the 5G Core Network (5GC) 20 via the NG interface.

Although not explicitly shown here, as specified in TS 38.300 v17.0.0, which is incorporated herein by reference in its entirety, the NG-RAN 30 could also comprise a set of Next Generation enhanced NodeBs (ng-eNBs). An ng-eNB may comprise a ng-eNB Central Unit (ng-eNB-CU) and one or more ng-eNB-Distributed Units (ng-eNB-DUs). An ng-eNB-CU and an ng-eNB-DU are connected via a W1 interface.

As seen in FIG. 1, a gNB 32, 34 can support multiple modes, including a Frequency-division duplexing (FDD) mode, a Time-division duplexing (TDD) mode, and a dual mode operation mode, and can be interconnected through an Xn interface. A gNB, such as gNB 34, may comprise a gNB-CU 36 and one or more gNB-DU(s) 38a, 38b (collectively, 38), with the gNB-CU 36 connecting to a gNB-DU 38 via an F1 interface. One gNB-DU 38 is connected to only one gNB-CU 36.

In cases of network sharing with multiple cell ID broadcast, each Cell Identity (CI) is associated with a subset of Public Land Mobile Networks (PLMNs) corresponding to a gNB-DU 38 and the gNB-CU 36 to which it is connected (i.e., the corresponding gNB-DUs 38 share the same physical layer cell resources). Further, for resiliency, a gNB-DU 38 may be connected to multiple gNB-CUs 36 by appropriate implementation.

The NG, Xn and F1 interfaces illustrated in FIG. 1 are logical interfaces. For NG-RAN 30, the NG and Xn-C interfaces for a gNB 34 comprising a gNB-CU 36 and gNB-DUs 38 terminate in the gNB-CU 36. For E-UTRAN New Radio-Dual Connectivity (EN-DC), the S1-U and X2-C interfaces for a gNB 34 comprising a gNB-CU 36 and corresponding gNB-DUs 38 terminate in the gNB-CU 36. The gNB-CU 36 and connected gNB-DUs 38 are only visible to other gNBs 32 and the 5GC 20 as a gNB.

The node hosting user plane part of New Radio (NR) Packet Data Convergence Protocol (PDCP) (e.g., the gNB-CU, gNB-CU-UP, and for EN-DC, the MeNB or SgNB depending on the bearer split) performs user inactivity monitoring, and further, reports its inactivity or (re) activation to a node having a C-plane connection towards the core network (e.g., over E1, X2). The node hosting the NR Radio Link Control (RLC) (e.g., the gNB-DU) may perform user inactivity monitoring and further report its inactivity or (re) activation to the node hosting control plane (e.g., the gNB-CU or gNB-CU-CP).

The Uplink (UL) PDCP configuration (i.e., how the UE uses the UL at the assisting node) is indicated via X2-C (for EN-DC), Xn-C (for NG-RAN) and F1-C. Radio Link Outage/Resume for DL and/or UL is indicated via X2-U (for EN-DC), Xn-U (for NG-RAN) and F1-U.

The NG-RAN 30 is layered into a Radio Network Layer (RNL) and a Transport Network Layer (TNL). The NG-RAN architecture 10, i.e., the NG-RAN logical nodes and interfaces between them, is defined as part of the RNL. For each NG-RAN interface (e.g., NG, Xn, F1) the related TNL protocol and the functionality are specified. The TNL provides services for user plane transport, signaling transport.

In NG-Flex configurations, each NG-RAN node is connected to all Access and Mobility Management Functions (AMFs) of AMF Sets within an AMF Region supporting at least one slice that is also supported by the NG-RAN node. The AMF Set and the AMF Region are defined in 3GPP TS 23.501 v17.6.0, which is incorporated herein by reference in its entirety. If security protection for the control plane and the user plane data on the TNL of the NG-RAN interfaces has to be supported, NDS/IP 3GPP TS 33.501 shall be applied.

### Overall Architecture for Separation of gNB-CU-CP and qNB-CU-UP

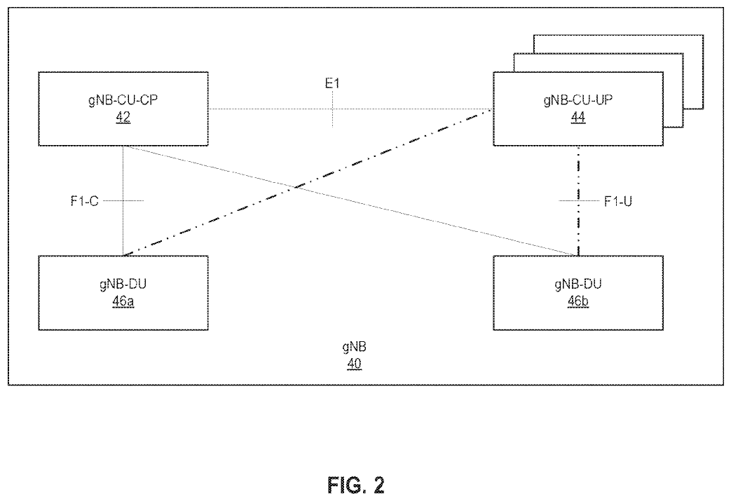

The overall architecture for separation of gNB-CU-CP and gNB-CU-UP is illustrated in FIG. 2 and specified in TS 37.483 v17.2.0, which is incorporated herein by reference in its entirety. As seen in FIG. 2, a gNB 40 may comprise a gNB-CU-CP 42, multiple gNB-CU-UPs 44, and multiple gNB-Dus 46a, 46b (collectively, 46). Additionally, the gNB-CU-CP 42 is connected to the gNB-DU 46 through the F1-C interface, and the gNB-CU-UP 44 is connected to the gNB-DU 46 through the F1-U interface. The gNB-CU-UP 44 is connected to the gNB-CU-CP 42 through the E1 interface, and one gNB-DU 46 is connected to only one gNB-CU-CP 42. Further, one gNB-CU-UP 44 is connected to only one gNB-CU-CP 42.

For resiliency, however, a gNB-DU 46 and/or a gNB-CU-UP 44 may be connected to multiple gNB-CU-CPs 42 by appropriate implementation. Additionally, one gNB-DU 46 can be connected to multiple gNB-CU-UPs 44 under the control of the same gNB-CU-CP 42, and one gNB-CU-UP 44 can be connected to multiple gNB-DUs 46 under the control of the same gNB-CU-CP 42.

The connectivity between a gNB-CU-UP 44 and a gNB-DU 46 is established by the gNB-CU-CP 42 using Bearer Context Management functions. Further, the gNB-CU-CP 42 selects the appropriate gNB-CU-UP(s) 44 for the requested services for the User Equipment (UE). In cases where there are multiple gNB-CU-UPs 44, they belong to a same security domain as defined in TS 33.210 v17.1.0, which is incorporated herein by reference in its entirety. Data forwarding between gNB-CU-UPs 44 during intra-gNB-CU-CP42 handover within a gNB 40 may be supported by Xn-U.

### Dual Connectivity

In dual connectivity, a UE capable of multiple transmission/receptions, may be connected to more than one RAN node. The RAN nodes may be of the same RAT (both master node and secondary node in NR or LTE respectively) or different RATs, e.g., one master LTE node and one secondary NR node. In specification TS 37.340 v17.2.0, which is incorporated herein by reference in its entirety, the principles of multi-radio dual connectivity are described.

Multi-Radio Dual Connectivity (MR-DC) is a generalization of the Intra-E-UTRA Dual Connectivity (DC) described in TS 36.300 v17.2.0, which is incorporated herein by reference in its entirety. As described in TS 36.300 v17.2.0, multiple Rx/Tx capable UE may be configured to utilize resources provided by two different nodes connected via non-ideal backhaul. More specifically, one node provides NR access and the other node provides either E-UTRA or NR access. One node also functions as the Master Node (MN) while the other node functions as the Secondary Node (SN). The MN and SN are connected via a network interface and at least the MN is connected to the core network. The MN and/or the SN can be operated with shared spectrum channel access.

All functions specified for a UE may be used for an IAB-MT unless otherwise stated. Similarly for a UE, the IAB-MT can access the network using either one network node or using two different nodes with EN-DC and NR-DC architectures. In EN-DC, the backhauling traffic over the E-UTRA radio interface is not supported.

The MR-DC is designed based on the assumption of non-ideal backhaul between the different nodes but can also be used in case of ideal backhaul. Additionally, all MR-DC normative text and procedures illustrate the aggregated node case. The details regarding non-aggregated node for MR-DC operation are described in TS 38.401 v17.2.0, which is incorporated herein by reference in its entirety.

### MR-DC with the EPC

The Evolved Universal Terrestrial Radio Access Network (E-UTRAN) supports MR-DC via E-UTRA-NR Dual Connectivity (EN-DC), in which a UE is connected to one eNB that functions as an MN, and one en-gNB that functions as an SN. The eNB is connected to the EPC via the S1 interface and to the en-gNB via the X2 interface. The en-gNB might also be connected to the EPC via the S1-U interface and other en-gNBs via the X2-U interface.

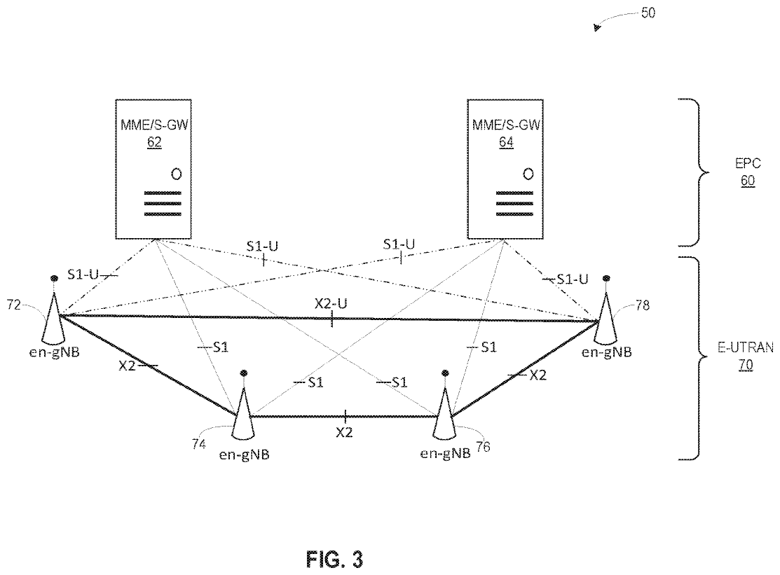

FIG. 3 illustrates an overall EN-DC architecture 50, which comprises an Evolved Packet Core (EPC) 69 and an Evolved Universal Terrestrial Radio Access Network (E-UTRAN) 70. The EPC 60 comprises one or more MME/S-GW nodes 62, 64 and the E-UTRAN 70 comprises a plurality of en-gNBs 72, 74, 76, 78. As stated above, the en-gNBs 72, 74, 76, 78 are communicatively connected to each other via an X2 or X2-U interface, and to the MME/S-GW nodes 62, 64 via an S1 or S1-U interface.

As described in TS 37.340 v17.2.0, the NG-RAN supports NG-RAN E-UTRA-NR Dual Connectivity (NGEN-DC), NR-E-UTRA Dual Connectivity (NE-DC), and NR-NR Dual Connectivity (NR-DC).

### MR-DC with the 5GC-E-UTRA-NR Dual Connectivity

In situations where NG-RAN is supporting NGEN-DC, a UE is connected to one ng-eNB that functions as an MN and a gNB that functions as an SN.

### NR-E-UTRA Dual Connectivity

In situations where NG-RAN is supporting NE-DC, a UE is connected to one gNB that acts as a MN and one ng-eNB that acts as a SN.

### NR-NR Dual Connectivity

In situations where NG-RAN is supporting NR-DC, a UE is connected to one gNB that functions as a MN and another gNB that functions as a SN. Additionally, NR-DC can also be used when a UE is connected to two gNB-DUs, one serving the Master Cell Group (MCG) and the other serving the Secondary Cell Group (SCG), or when the UE is connected to the same gNB-CU acting both as a MN and as a SN.

### QoE Framework Overview

### Regular” QoE

Quality of Experience (QoE) measurements, also referred to as “application layer measurements”, have been specified for LTE and UMTS and are being specified for NR in 3GPP release 17. The purpose of the application layer measurements is to measure the end user experience when using certain applications. Currently, QoE measurements for streaming services and for Mobility Telephony Service for IMS (MTSI) services are supported. However, for NR, it is likely that at least VR will be added to the list of services for which QoE measurements will be specified and supported.

The overall principles of the solutions in LTE and UMTS are similar. Quality of Experience Measurement Collection (QMC) enables configuration of application layer measurements in the UE, as well as the transmission of QoE measurement result files (referred to herein as “QoE reports”) to the network by means of RRC signaling. An application layer measurement configuration (also called QoE measurement configuration or QoE configuration) that the RAN receives from the Operation and Maintenance (OAM) system, or the Core Network (CN), is encapsulated in a transparent container that is forwarded to a UE in a downlink RRC message. An application layer measurement report (also referred to herein as a QoE report) that the UE Access Stratum (UE AS) or UE RRC layer receives from the UE's higher layer (i.e., the application layer) is encapsulated in a transparent container and sent to network in an uplink RRC message. The RAN then forwards the QoE report to a Measurement Collector Entity (MCE).

In 3GPP release 17, a new study item for “Study on NR QoE management and optimizations for diverse services” for NR has been approved and concluded. The specification work for 3GPP release 17 is still ongoing. The purpose of the study item is to study solutions for QoE measurements in NR. QoE management in NR will not just collect the quality of experience parameters of streaming services but will also consider the typical performance requirements of diverse services (e.g., Augmented Reality (AR)/Virtual Reality (VR) and Ultra-Reliable Low Latency Communications (URLLC), of which at least VR seems to be covered in 3GPP release 17). Based on the requirements of the services, the NR study also included more adaptive QoE management schemes that enable network optimization to satisfy user experience for diverse services.

The configuration data related to QoE measurements (typically referred to as application layer measurements in standard specifications) consists of a service type indication, an indication of an area in which the measurements are to be performed (i.e., a denoted area scope), an IP address of the entity (i.e., often referred to as a “MCE”-Measurement Collector Entity or Measurement Collection Entity, but also sometimes referred to as a “Trace Collection Entity”) to which the collected measurement results (i.e., the QoE reports) should be sent, and a set of instructions of which type of measurements that should be performed, as well as the details of how these measurements are to be performed. These instructions are intended for the application layer in the UE and are placed in a “container” that the handling network entities (e.g., the network entities forwarding the instructions to the UE), as well as the UE AS, cannot interpret and do not try to read. The currently specified service types are MTSI and streaming service (DASH). However, in 3GPP release 17, at least the service type VR will be added.

An area scope is defined in terms of cells or network related areas. In Universal Mobile Telecommunication System (UMTS), an area scope is defined as either a list of cells, a list of routing areas, or a list of tracking areas. In LTE, an area scope is defined as either a list of cells or a list of tracking areas. In NR, an area scope will be defined similarly to LTE—i.e., as either a list of cells or a list of tracking areas.

QoE, and in particular QoE configuration, comes in two flavors: management-based QoE configuration and signaling-based QoE configuration. In both cases, the QoE configuration originates in the OAM system or some other administrational entity (e.g., dealing with customer satisfaction). All of these entities in this document are referred to as the OAM system (where the OAM system also contains additional entities). With management-based QoE (m-based QoE), the OAM system is typically interested in general QoE statistics from a certain area (which is configured as an area scope). The m-based QoE configuration is sent directly from the OAM system to the RAN nodes controlling cells that are within the area scope. Each RAN node then selects the UEs that are within the area scope (and also fulfills any other relevant condition, such as supporting the concerned application/service type) and sends the m-based QoE configuration to these UEs.

With signaling-based QoE (s-based QoE), however, the OAM system is interested in collecting QoE measurement results from a specific UE (e.g., because the user of the UE has filed a complaint). The OAM system sends the s-based QoE configuration to the Home Subscriber Server (HSS) (in Evolved Packet System (EPS)/LTE) or Unified Data Management (UDM) (in 5GS/NR), which then forwards the QoE configuration to the UE's current core network (CN) node (e.g., a Mobility Management Entity (MME) in EPS/LTE or an Access and Mobility Management Function (AMF) in 5G/NR). The CN node then forwards the s-based QoE configuration to the RAN node that serves the concerned UE and the RAN forwards it to the UE.

The service type indication and the container with the measurement instructions are forwarded to the UE; however, the UE is not aware of whether a received QoE configuration is m-based or s-based. In legacy systems, the QoE framework is integrated with the Trace functionality and a Trace ID is associated with each QoE configuration. In NR, the QoE functionality will be logically separated from the Trace functionality but will still partly reuse the Trace signaling mechanisms. In NR and LTE, a globally unique QoE reference (formed as a concatenation of the Mobile Country Code (MCC)+the Mobile Network Code (MNC)+the QoE Measurement Collection (QMC) ID, where the QMC ID is a string of 24 bits) will be associated with each QoE configuration. The QoE reference is included in the container with measurement instructions and is also sent to the RAN (i.e., the gNB in NR). For the communication between the gNB and the UE, the QoE reference is replaced by a shorter identifier denoted as measConfigAppLayerId, which is locally unique within a UE (i.e., there is a one-to-one mapping between a measConfigAppLayerId and a QoE reference for each QoE configuration provided to a UE). The measConfigAppLayerId is stored in the UE AS and also forwarded in an Attention (AT) Command (which is the type of instructions used in communications between the UE's application layer the UE's modem) together with the service type indication and the container with the measurement instructions.

Reports with collected QoE measurement results (i.e., the QoE reports) are sent from the UE application layer to the UE AS. The UE AS then forwards the QoE reports to the RAN, which in turn, forwards them to the MCE. These QoE reports are placed in a “container”, which is uninterpretable for the UE AS and the RAN. QoE reporting is configurable. In one embodiment, for example, the UE is configured to send the QoE reports periodically. In other embodiments, the UE is configured to send the QoE reports upon completion of an application session. Additionally, the RAN can instruct the UE to pause QoE reporting in cases where the cell/gNB is in a state of overload, for example.

Neither the RAN nor the UE AS are aware of when an application session with an associated QoE measurement session is on-going. To alleviate this, session start/stop indications can be introduced, which are sent from the application layer in the UE to the UE AS and from the UE AS to the RAN. A session stop indication may be implicit in the form of a QoE report sent when the application session and the associated QoE measurement session are concluded.

The RAN may decide to release a QoE configuration to a UE at any time, as an implementation-based decision. Typically, this is done when the UE has moved outside an area configured for the QoE measurements (i.e., the area commonly referred to as the area scope).

One opportunity provided by legacy solutions is also to be able to keep the QoE measurements for the entire session, even during handover situations. It has also been discussed to let the UE continue with the QoE measurements on an ongoing application session until the application session ends, even if the UE in the meantime moves out of the configured area scope.

### RAN visible QoE (RVQoE)

In NR, 3GPP Release 17 introduced RAN visible QoE measurements. A general description can be found in clause 21.4 of 3GPP TS 38.300 v17.0.0.

RAN visible QoE measurements are configured by the NG-RAN node, where a subset of QoE metrics is reported from the UE as an explicit Information Element (IE) that is readable by the NG-RAN node. RAN visible QoE measurements (e.g., RAN visible QoE metrics, RAN visible QoE values, etc.) could be utilized by the NG-RAN node for network optimization. RAN visible QoE measurements are supported for the DASH streaming and VR services. The NG-RAN node configures the RAN visible QoE measurements for collection of all or some of the available RAN visible QoE metrics, where the indication of metric availability is received from the OAM or CN. The set of available RAN visible QoE metrics is a subset of the metrics which are already configured as part of QoE measurement configuration encapsulated in the transparent container. The Protocol Data Unit (PDU) session ID(s) corresponding to the service that is subject to QoE measurements can also be reported by the UE along with the RAN visible QoE measurement results.

A request to collect QoE measurements that are not visible to the RAN (also referred to as “OAM-QoE” in R3-223290 dated Apr. 26, 2022, which is incorporated herein by reference in its entirety) originates from the OAM and is identified by a QoE Reference. A definition for this identifier can be found, e.g., in clause 5.2 of 3GPP TS 28.405 v17.1.0, which states:
The QoE reference parameter specifies the network request session. The QoE reference shall be globally unique therefore it is composed as follows:
MCC+MNC+QMC ID, where the MCC and MNC are coming with the QMC activation request from the management system to identify one PLMN containing the management system, and QMC ID is a 3 byte Octet String.

The QMC ID is generated by the management system or the operator.

It is used to identify the QoE measurement collection job in the traffic nodes and in the measurement collection center.

The UE AS layer can report the RAN visible QoE measurements in RRC format to a gNB and a UE application layer can be configured for performing more application layer measurements at the same time (see NR Rel-17 up to 16). Additionally, as described in TS 38.331 v17.2.0 for example, which is incorporated herein by reference in its entirety, an application layer measurement is identified by the MeasConfigAppLayerId IE.

In a gNB, RAN visible QoE information can be transferred from gNB-CU to the gNB-DU in a procedure described in TS 38.473 v17.0.0, which is incorporated herein by reference in its entirety. The procedure is UE-associated. That is, the procedure is specific for a UE.

### Network Characteristics

### HSDN Cells

As indicated in 3GPP TS 36.304 v17.2.0, which is incorporated herein by reference in its entirety, a High Speed Digital Network (HSDN) cell has a higher priority than other cells for cell reselection for HSDN capable UEs in a High-mobility state. This is further described below, and also in clause 5.2.4.1 of 3GPP TS 36.304. Particularly:
When the HSDN capable UE is in High-mobility state, the UE shall always consider the HSDN cells to be the highest priority (i.e., higher than any other network configured priorities). When the HSDN capable UE is not in a High-mobility state, the UE shall always consider HSDN cells to be the lowest priority (i.e., lower than network configured priorities).

An HSDN cell is signaled in TS 36.331 v17.2.0, which is incorporated herein by reference in its entirety, by the field hsdn-Cell, broadcasted in the System Information as shown below.

```
SystemInformationBlockType1-v1530-IEs ::=  SEQUENCE {
  hsdn-Cell-r15  ENUMERATED {true} OPTIONAL, -- Need OR
  cellSelectionInfoCE-v1530  CellSelectionInfoCE-v1530 OPTIONAL, -- Need OP
  crs-IntfMitigConfig-r15  CHOICE {
    crs-IntfMitigEnabled  NULL,
    crs-IntfMitigNumPRBs  ENUMERATED {n6, n24}
  }  OPTIONAL,  -- Need OR
  cellBarred-CRS-r15 ENUMERATED {barred, notBarred},
  plmn-IdentityList-v1530  PLMN-IdentityList-v1530 OPTIONAL, -- Need
OR
  posSchedulingInfoList-r15 PosSchedulingInfoList-r15 OPTIONAL, --
Need OR
  cellAccessRelatedInfo-5GC-r15   SEQUENCE {
    cellBarred-5GC-r15  ENUMERATED {barred, notBarred},
    cellBarred-5GC-CRS-r15 ENUMERATED {barred, notBarred},
    cellAccessRelatedInfoList-5GC-r15 SEQUENCE (SIZE (1..maxPLMN-r11)) OF
      CellAccessRelatedInfo-5GC-r15
  }  OPTIONAL, -- Need OP
  ims-EmergencySupport5GC-r15  ENUMERATED {true} OPTIONAL,  -- Need OR
  eCallOverIMS-Support5GC-r15  ENUMERATED {true} OPTIONAL,  -- Need OR
  nonCriticalExtension  SystemInformationBlockType1-v1540-IEs
  OPTIONAL
}
```

### CSG Cells

A Closed Subscriber Group (CSG) cell is a cell broadcasting a CSG indication, set to true and a specific CSG Identity (CSG ID) which identifies the Closed Subscriber Group the cell belongs to.

The related RRC signaling is shown below (TS 36.331).

| SystemInformationBlockType1 ::= | SEQUENCE { | | |
|---|---|---|---|
| cellAccessRelatedInfo | SEQUENCE { | | |
| plmn-IdentityList | PLMN-Identity List, | | |
| trackingAreaCode | TrackingAreaCode, | | |
| cellIdentity | CellIdentity, | | |
| cellBarred | ENUMERATED {barred, notBarred}, | | |
| intraFreqReselection | ENUMERATED {allowed, notAllowed}, | | |
| csg-Indication | BOOLEAN, | | |
| csg-Identity | CSG-Identity OPTIONAL -- Need OR | | |
| }, | | | |
| cellSelectionInfo | SEQUENCE { | | |
| q-RxLevMin | Q-RxLevMin, | | |
| q-RxLevMinOffset | INTEGER (1..8) | OPTIONAL | -- Need OP |
| }, | | | |
| p-Max | P-Max | OPTIONAL, | -- Need OP |
| freqBandIndicator | FreqBandIndicator, | | |
| schedulingInfoList | SchedulingInfoList, | | |
| tdd-Config | TDD-Config | OPTIONAL, | -- Cond TDD |

si-WindowLength ENUMERATED {ms1, ms2, ms5, ms10, ms15, ms20,ms40},

| | |
|---|---|
| systemInfoValueTag | INTEGER (0..31), |

| | |
|---|---|
| nonCriticalExtension SystemInformationBlockType1-v890-IEs | OPTIONAL |

### Support for Non-Public Network

Non-Public networks (NPN) are intended for the sole use of a private entity, such as an enterprise, for example, and may be deployed in a variety of configurations utilizing both virtual and physical elements. Specifically, NPNs may be deployed as completely standalone networks, or they may be hosted by a PLMN, or they may be offered as a slice of a Public Land Mobile Network (PLMN).

In any of these deployment options, it is expected that unauthorized UEs (i.e., those that are not associated with the enterprise), will not attempt to access the NPN, which could result in resources being used to reject that UE and thereby not be available for the UEs of the enterprise. It is also expected that the UEs of the enterprise will not attempt to access a network they are not authorized to access. For example, some enterprise UEs may be restricted to only access the non-public network of the enterprise even if PLMN coverage is available in the same geographic area. Other enterprise UEs may be able to access both a non-public network and a PLMN where specifically allowed.

As described in 3GPP TS 23.501, a Non-Public Network (NPN) is a 5GS deployed for non-public use and an NPN is either:
a Stand-alone Non-Public Network (SNPN), i.e., operated by an NPN operator and not relying on network functions provided by a PLMN, or
a Public Network Integrated NPN (PNI-NPN), i.e., a non-public network deployed with the support of a PLMN.

### Stand-Alone Non-Public Network

A SNPN is identified by the combination of a PLMN ID and a Network identifier (NID). NG-RAN nodes which provide access to SNPNs broadcast the following information:
One or multiple PLMN IDs;
List of NIDs per PLMN ID identifying the non-public networks the NG-RAN provides access to;
Optionally, a human-readable network name per NID;
Optionally, information as described in TS 38.300, TS 38.331 and in TS 38.304 v17.2.0, which is incorporated herein by reference in its entirety, to prevent UEs not supporting SNPNs from accessing the cell (e.g., if the cell only provides access to non-public networks).

### Public Network Integrated NPNs

Public Network Integrated NPNs are NPNs made available via PLMNs (e.g., by means of dedicated DNNs or by one or more Network Slice instances allocated for the NPN). When a PNI-NPN is made available via a PLMN, then the UE shall have a subscription for the PLMN in order to access PNI-NPN.

A Closed Access Group (CAG) identifies a group of subscribers who are permitted to access one or more CAG cells associated to the CAG. The CAG is used for the PNI-NPNs to prevent UE(s), which are not allowed to access the NPN via the associated cell(s), from automatically selecting and accessing the associated CAG cell(s).

A CAG cell is a cell broadcasting at least one CAG identity. A CAG-only cell is a cell that is only available for normal service for CAG UEs.

### RRC Signaling for NPN Support

Some RRC signaling related to NPN support is shown below (ref: 3GPP TS 38.331).

```
CellAccessRelatedInfo  ::=  SEQUENCE {
  plmn-IdentityList  PLMN-IdentityInfoList,
  cellReservedForOtherUse  ENUMERATED {true}  OPTIONAL, -- Need R
  ...,
  [[
  cellReservedForFutureUse-r16  ENUMERATED {true}  OPTIONAL, -- Need R
  npn-IdentityInfoList-r16  NPN-IdentityInfoList-r16 OPTIONAL -- Need R
  ]]
}
NPN-IdentityInfoList-r16 ::=  SEQUENCE (SIZE (1..maxNPN-r16)) OF NPN-IdentityInfo-
r16
NPN-IdentityInfo-r16 ::=  SEQUENCE {
  npn-IdentityList-r16  SEQUENCE (SIZE (1..maxNPN-r16)) OF NPN-Identity-r16,
  trackingAreaCode-r16  TrackingAreaCode,
  ranac-r16  RAN-AreaCode OPTIONAL, -- Need R
  cellIdentity-r16  CellIdentity,
  cellReservedForOperatorUse-r16  ENUMERATED {reserved, notReserved},
  ...
}
NPN-Identity-r16 ::=  CHOICE {
  pni-npn-r16  SEQUENCE {
    plmn-Identity-r16  PLMN-Identity,
    cag-IdentityList-r16  SEQUENCE (SIZE (1..maxNPN-r16)) OF CAG-Identity-r16
  },
  snpn-r16  SEQUENCE {
      plmn-Identity  PLMN-Identity,
      nid-List-r16  SEQUENCE (SIZE (1..maxNPN-r16)) OF NID-r16
  }
}
CAG-Identity-r16 ::=  BIT STRING (SIZE (32))
NID-r16 ::=  BIT STRING (SIZE (52))
```

### NPN-Only Cell

As defined in 3GPP TS 38.331, an NPN-only cell is a cell that is only available for normal service for the NPN's subscriber(s). An NPN-capable UE determines that a cell is an NPN-only cell by detecting that the cellReservedForOtherUse IE is set to true while the npn-IdentityInfoList IE is present in CellAccessRelatedInfo.

### IAB-Nodes

An IAB-node is a RAN node that supports NR access links to the UEs and NR backhaul links to parent nodes and child nodes. The NG-RAN supports IAB by the IAB-node wirelessly connecting to the gNB capable of serving the IAB-nodes, named IAB-donor.

The IAB-donor consists of an IAB-donor-CU and one or more IAB-donor-DU(s). In case of separation of gNB-CU-CP and gNB-CU-UP, the IAB-donor may consist of an IAB-donor-CU-CP, multiple IAB-donor-CU-UPs and multiple IAB-donor-DUs.

The IAB-node connects to an upstream IAB-node or an IAB-donor-DU via a subset of the UE functionalities of the NR Uu interface (named IAB-MT function of IAB-node). The IAB-node provides wireless backhaul to the downstream IAB-nodes and UEs via the network functionalities of the NR Uu interface (named IAB-DU function of IAB-node).

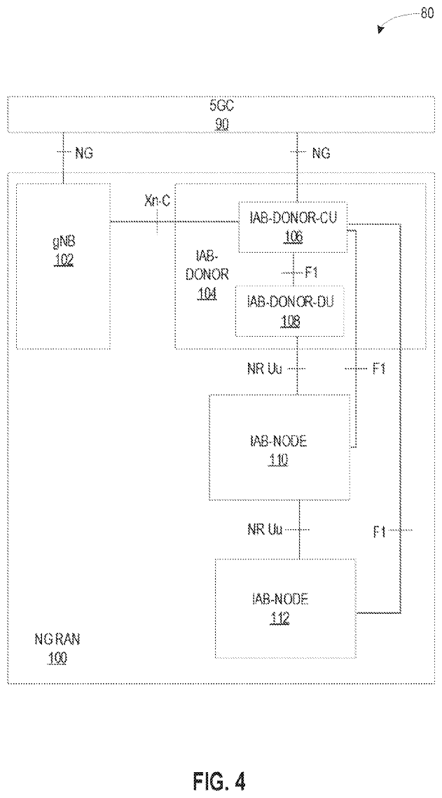

The overall architecture 80 of the IAB is shown in FIG. 4. For more information regarding architecture 80 and its components, the interested reader is directed to 3GPP TS 38.401. However, in this embodiment, architecture 80 comprises a 5G Core Network (5GC) 90 and a NG-RAN 100 communicatively connected to each other via a NG interface. As seen in FIG. 4, NG-RAN 100 comprises a gNB 102, an IAB-DONOR node 104, and one or more IAB-Nodes 110, 112. The IAB-DONOR node 104 further comprises an IAB-DONOR-CU 106 and an IAB-DONOR-DU 108. According to the present disclosure, the IAB-DONOR-CU 106 communicatively couples to a gNB 102 via an Xn-C interface, and to the IAB-NODES 110, 112 via respective F1 interfaces. The IAB-DONOR-DU 108 is communicatively connected to the IAB-Nodes 110, 112 via a NR Uu interface.

According to 3GPP TS 33.331, an IAB node 110, 112 connecting itself to an upstream node, e.g., an IAB donor node 104, can indicate that it is an IAB node 110, 112 (rather than a regular UE) by setting the iab-NodeIndication-r16 to ‘true’ in the RRCSetupComplete message (ASN.1 definition below):

```
RRCSetupComplete-v1610-IEs ::=  SEQUENCE {
  iab-NodeIndication-r16  ENUMERATED {true} OPTIONAL,
  idleMeasAvailable-r16  ENUMERATED {true}  OPTIONAL,
  ueMeasurementsAvailable-r16  UEMeasurementsAvailable-r16 OPTIONAL,
  mobilityHistoryAvail-r16  ENUMERATED {true}  OPTIONAL,
  mobilityState-r16  ENUMERATED {normal, medium, high, spare}  OPTIONAL,
  nonCriticalExtension  SEQUENCE{ }  OPTIONAL
}
```

Moreover, IAB support is indicated in TS 38.331 as part of PLMN Identity broadcasted in System Information Block 1 (SIB1) within cellAccessRelatedInfo IE.

### PLMN-IdentityInfoList

```
PLMN-IdentityInfoList ::= SEQUENCE (SIZE (1..maxPLMN)) OF PLMN-IdentityInfo
PLMN-IdentityInfo ::=  SEQUENCE {
  plmn-IdentityList  SEQUENCE (SIZE (1..maxPLMN)) OF PLMN-Identity,
  trackingAreaCode  TrackingAreaCode  OPTIONAL, -- Need R
  ranac  RAN-AreaCode  OPTIONAL, -- Need R
  cellIdentity  CellIdentity,
  cellReservedForOperatorUse  ENUMERATED {reserved, notReserved},
  ...,
  [[
  iab-Support-r16  ENUMERATED {true} OPTIONAL -- Need R
  ]]
}
```

PLMN-IdentityInfo field descriptions

cellReservedForOperatorUse
Indicates whether the cell is reserved for operator use (per PLMN), as defined in TS 38.304.
iab-Support
This field combines both the support of IAB-node and the cell status for IAB-node. If the field
is present, the cell supports IAB-nodes and the cell is also considered as a candidate for IAB-
nodes; if the field is absent, the cell does not support IAB and/or the cell is barred for IAB-
node.
trackingAreaCode
Indicates Tracking Area Code to which the cell indicated by cellIdentity field belongs. The
absence of the field indicates that the cell only supports PSCell/SCell functionality (per
PLMN).

### Slice Support

A network slice instance is defined within a PLMN and shall include:
the Core Network Control Plane and User Plane Functions and, in the serving PLMN, at least one of the following:
   the NG-RAN;
   the N3IWF or TNGF functions to the non-3GPP Access Network or the TWIF functions to the trusted WLAN in the case of support of N5CW devices;
   the W-AGF function to the Wireline Access Network.

Network slices may differ for supported features and network function optimizations. In such cases, the network slices may have e.g., different Single Network Slice Selection Assistance Information (S-NSSAIs) with different slice/service types. An S-NSSAI identifies a network slice and comprises:
A Slice/Service type (SST): This refers to the expected Network Slice behavior in terms of features and services; and.
A Slice Differentiator (SD): This is optional information that complements the Slice/Service type(s) and differentiates among multiple network slices of the same Slice/Service type.

Standardized SST values provide a way for establishing global interoperability for slicing so that PLMNs can support the roaming use case more efficiently for the most commonly used Slice/Service Types. The SSTs, which are standardized, are specified in Table 1 below (i.e., Table 5.15.2.2-1 in TS 23.501).

TABLE 1

| Slice/ | SST | |
|---|---|---|
| Service type | value | Characteristics |
| eMBB | 1 | Slice suitable for the handling of 5G |
| | | enhanced Mobile Broadband. |
| URLLC | 2 | Slice suitable for the handling of ultra- |
| | | reliable low latency communications. |
| MIoT | 3 | Slice suitable for the handling of massive IoT. |
| V2X | 4 | Slice suitable for the handling of V2X services. |

### An Example of Filtering Criteria

An example of a Next Generation Application Protocol (NGAP) UE Application Layer Measurement Configuration Information IE containing a filtering criterion called “Area Scope for QMC” is shown below in Table 2. For example, the choice option “Cell Based” contains the list of cells in which the measurements shall be conducted.

### UE Application Layer Measurement Configuration Information

This IE defines configuration information for the QMC functionality.

TABLE 2

| | | | IE type and | |
|---|---|---|---|---|
| IE/Group Name | Presence | Range | reference | Semantics description |
| QoE Reference | M | | OCTET | QoE Reference, as defined |
| | | | STRING | in clause 5.2 of TS 28.405 |
| | | | (SIZE(6)) | [45]. It consists of |
| | | | | MCC + MNC + QMC ID, |
| | | | | where the MCC and MNC |
| | | | | are coming with the QMC |
| | | | | activation request from the |
| | | | | management system to |
| | | | | identify one PLMN |
| | | | | containing the management |
| | | | | system, and QMC ID is a 3- |
| | | | | bytes Octet String. |
| Service Type | M | | ENUMERATED | This IE indicates the service |
| | | | (QMC for DASH | type of QoE measurements. |
| | | | streaming, | |
| | | | QMC for MTSI, | |
| | | | QMC for VR, . . . ) | |
| CHOICE Area | M | | | |
| Scope of QMC | | | | |
| Cell based | | | | |
| Cell ID List for | | 1 . . . | | |
| QMC | | <maxnoofCellIDforQMC> | | |
| NG-RAN | M | | 9.3.1.73 | This IE can only indicate the |
| CGI | | | | NR CGI. |
| TA based | | | | |
| TA List for | | 1 . . . | | |
| QMC | | <maxnoofTAforQMC> | | |
| TAC | M | | 9.3.3.10 | The TAI is derived using the |
| | | | | current serving PLMN. |
| TAI based | | | | |
| TAI List for | | 1 . . . | | |
| QMC | | <maxnoofTAforQMC> | | |
| TAI | M | | 9.3.3.11 | |
| PLMN area based | | | | |
| PLMN List for | | 1 . . . | | |
| QMC | | <maxnoofPLMNforQMC> | | |
| PLMN | M | | 9.3.3.5 | |
| Identity | | | | |
| Measurement | M | | Transport Layer | The IP address of the entity |
| Collection Entity IP | | | Address | receiving the QoE |
| Address | | | 9.3.2.4 | measurement report. |
| QoE Measurement | O | | ENUMERATED | Indicates whether the QoE |
| Status | | | (ongoing, . . . ) | measurement has been |
| | | | | started. Present in case of |
| | | | | NG-based handover. |
| Container for | O | | OCTET | Contains application layer |
| Application Layer | | | STRING | measurement configuration, |
| Measurement | | | (SIZE(1 . . . 8000)) | see Annex L in 26.247 [46], |
| Configuration | | | | clause 16.5 in TS 26.114 |
| | | | | [51] and clause 9 in TS |
| | | | | 26.118 [52]. Present in case |
| | | | | of initial QoE configuration, |
| | | | | and shall be included in |
| | | | | Source to Target |
| | | | | Transparent Container IE |
| | | | | for signaling-based QMC |
| | | | | during NG-based handover. |
| Measurement | O | | INTEGER | This IE is present only when |
| Configuration | | | (0 . . . 15, . . . ) | the message containing it is |
| Application Layer | | | | NG-based handover |
| ID | | | | related. |
| | | | | The IE indicates the identity |
| | | | | of the application layer |
| | | | | measurement configuration, |
| | | | | as defined in TS 38.331 |
| | | | | [18]. |
| Slice Support List | | 0 . . . 1 | | |
| for QMC | | | | |
| Slice Support | | 1 . . . | | |
| QMC Item | | <maxnoofSNSSAIforQMC> | | |
| S-NSSAI | M | | 9.3.1.24 | |
| CHOICE MDT | O | | | Indicates the MDT |
| Alignment | | | | measurements with which |
| Information | | | | alignment is required. |
| S-based MDT | | | | |
| NG-RAN Trace | M | | OCTET | This IE is composed of the |
| ID | | | STRING | following: Trace Reference |
| | | | (SIZE(8)) | defined in TS 32.422 [11] |
| | | | | (leftmost 6 octets, with |
| | | | | PLMN information encoded |
| | | | | as in 9.3.3.5), and Trace |
| | | | | Recording Session |
| | | | | Reference defined in TS |
| | | | | 32.422 [11] (last 2 octets). |
| Available RAN | O | | 9.3.1.225 | Present in case of initial |
| Visible QoE Metrics | | | | QoE configuration and in |
| | | | | case of NG-based handover |
| | | | | for signaling-based QoE |
| | | | | measurement. |

TABLE 3

| Range bound | Explanation |
|---|---|
| maxnoofCellIDforQMC | Maximum number of Cell ID subjects |
| | for QMC scope. Value is 32. |
| maxnoofTAforQMC | Maximum number of TA subjects for |
| | QMC scope. Value is 8. |
| maxnoofPLMNforQMC | Maximum number of PLMNs in the PLMN |
| | list for QMC scope. Value is 16. |
| maxnoofSNSSAIforQMC | Maximum number of S-NSSAIs in the |
| | S-NSSAI list for QMC scope. Value is 16. |

Currently, conventional QoE/RVQoE measurement frameworks use filtering parameters/criteria to limit the QoE/RVQoE measurement and reporting only to the cases/time periods when the criteria are fulfilled. A problem with these conventional frameworks, however, is that a UE configured for collecting QoE/RVQoE measurements according to certain filtering parameters will report only QoE/RVQoE measurements according to such filtering parameters. The UE will not conduct/report the QoE/RVQoE measurements that are not in accordance with these parameters (e.g., the UE will not perform measurements when the filtering parameters are not satisfied).

In some cases, it may be desirable to collect QoE/RVQoE measurements according to multiple filtering parameters from (potentially) multiple receivers where the multiple filtering parameters may or may not be complementary and/or contradictory. However, collecting the QoE/RVQoE measurements in such cases may not be performed efficiently by using a unique filter applied to a certain QoE/RVQoE configuration. This is because the QoE/RVQoE measurements and the corresponding QoE/RVQoE reports that will be collected do not allow the (potentially) multiple receivers to obtain the desirable QoE/RVQoE report in one QoE measurement campaign.

Embodiments of the present disclosure, however, address such issues. More particularly, according to the present disclosure, the claimed aspects enhance the QoE/RVQoE measurement reporting by extending the reporting with the inclusion of the filtering conditions as specified in the QoE/RVQoE configuration. As described in more detail below, the QoE/RVQoE measurement report is enhanced with information related to one or more of, or a combination of, at least the following:
UE speed/velocity;
Support for HSDN in the cells;
Support for CSG in the cells;
Support for SNPN networks in the cells (NPN-Identity);
Support for PNI-NPN networks in the cells (CAG cells);
Multicast Service/Broadcast Service/MBS/MBMS support in the cells;
Geographical Area Scope definition or filter criterion/criteria;
NB-IoT support in the cells; and.
Licensed Assisted Access (LAA) in the cells.

The embodiments disclosed herein provide benefits and advantages not available with conventional QoE/RVQoE measurement reporting methods. For example, the present embodiments provide enhancements to the QoE/RVQoE measurement reporting that enable a unique collection of measurements, which can later be filtered by multiple receivers based on their interest (i.e., based on their preference in terms of filtering criteria).

### The Method of the Present Disclosure as Implemented at the UE

According to at least one embodiment of the present disclosure, a UE may receive, from a RAN node, one or more filtering parameters to be used within or together with QoE/RVQoE reporting. The filtering parameters may be a part of a QoE configuration that is visible or not visible to a RAN node, or they may be associated with a QoE configuration or a RVQoE configuration. It should be noted here that, in one or more embodiments, the following options may be combined.

### Performing QoE/RVQoE Measurements

### Option 1

In this embodiment, a UE AS determines one or more identifiers, flags, or tags associated with a QoE/RVQoE measurement report according to the received filter parameters. The UE AS may then insert/append the one or more identifiers/flags/tags within/to the QoE/RVQoE measurements according to the received filter parameters, for example, and indicate which of the filtering criterion/criteria was/were fulfilled during the measurements that are included in the report.

The UE AS then sends a QoE/RVQoE report that is characterized based on the filter parameters to a RAN node. According to the present embodiments, the RAN node may be the same RAN node from which the QoE/RVQoE configuration was received or it may be a different RAN node.

### Option 2

In this embodiment, the UE application layer determines one or more identifiers, or flags, or tags associated with a QoE/RVQoE measurement report according to the received filter parameters.

The UE application layer inserts/appends one or more identifiers/flags/tags within/to the QoE/RVQoE measurements according to the received filter parameters, for example, and indicate which of the filtering criterion/criteria was/were fulfilled during the measurements included in the report.

The UE application layer then sends a QoE/RVQoE report characterized based on the filter parameters to a UE AS.

The UE AS then sends a QoE/RVQoE report characterized based on filter parameters to a RAN node. The RAN node may be the same RAN node from which the QoE/RVQoE configuration was received, or it may be a different RAN node.

In case the measurements between sending two consecutive QoE and/or RVQoE reports were collected according to two or more, complementary or contradicting, filter parameters (e.g., filter 1= “conduct measurements in high-speed data network cells”, and filter 2= “conduct measurements in non-high-speed data network cells”), the UE can divide the report in 2 or more parts. Each part corresponds to the measurements in accordance with one or more filtering parameters. For example, in a situation where a report is to be sent every 10 minutes, and the UE was in an HSDN cell for 6 minutes and in a non-HSDN cell for 4 minutes, two reports may be sent-one report corresponding to measurements collected while the UE was in an HSDN cell, and a second report corresponding to the measurements collected while the UE was in a non-HSDN cell.

According to the present disclosure, the RAN node sends one or more filtering parameters to a UE to characterize the QoE/RVQoE reports. For example, the RAN node may send the one or more filtering parameters as part of a QoE configuration that is not visible to the RAN node, or as part of a RVQoE configuration that is visible to the RAN node, or as filtering parameters associated with a QoE configuration, or as filtering parameters associated with a RVQoE configuration.

In one embodiment, the one or more filtering parameters are delivered to the UE. Upon receipt, the UE evaluates the filtering criteria and then performs the measurement collection and reporting according to the filtering criteria.

In another embodiment, the RAN node generates or receives the one or more filtering parameters from another entity and instructs the UE to perform measurements regardless of whether the criteria were fulfilled. The UE can, at the same time, be instructed to indicate in the reports whether the criteria were fulfilled, and which of the criteria were fulfilled. Upon receiving the reports from the UE, the RAN can check the criteria fulfillment indication provided by the UE, and based on the indication, decide whether to forward the report to another entity, e.g., the Distributed Unit (DU), the MCE, etc.

### Description

### UE Receiving Filtering Parameters to be Used for QoE/RVQoE Reporting

A UE AS and/or a UE application layer receive, from a RAN node (or via a RAN node), filtering parameters to characterize QoE/RVQoE reports as described below.

If the filtering parameters are received by the UE AS, the UE AS may forward the filtering parameters to the UE application layer via AT command with a request to return the filtering parameters in subsequent QoE/RVQoE reports.

In one embodiment, the filtering parameters may apply to QoE/RVQoE reports for any service type, or to a specific service type, or to a specific set of service types. Additionally, or alternatively, the filtering parameters may apply to QoE/RVQoE reports for QoE/RVQoE measurements collected by a UE in any RRC states, or in a specific RRC state, or in a certain set of RRC states.

### UE Access Stratum

The UE AS, based on a QoE/RVQoE configuration comprising filtering parameters to characterize QoE/RVQoE reports, or based on the reception of filtering parameters to characterize QoE/RVQoE reports associated with a QoE/RVQoE configuration (but sent separately), determines that subsequent QoE/RVQoE reports corresponding to the QoE/RVQoE configuration in question can be identified/flagged/tagged according to the received filtering parameters to characterize QoE/RVQoE reports.

The UE AS may receive, from the UE application layer, a QoE/RVQoE report which is not yet characterized based on filtering parameters and for which one or more filtering parameters were received in the corresponding QoE/RVQoE configuration. Responsive to receiving such a report, the UE AS can add one or more identifiers, or tags, or flags, to characterize the QoE/RVQoE report. According to one or more embodiments, the identifiers/flags/tags can be placed within the QoE/RVQoE reports or added to the QoE/RVQoE reports.

The UE AS sends one or more QoE/RVQoE reports characterized according to the filtering parameters to a RAN node. The RAN node to which the one or more reports are sent may be the RAN node from which the UE AS received the QoE/RVQoE configuration, the RAN node from which the UE AS received the filtering parameters to characterize QoE/RVQoE reports, and/or another RAN node. Sending the one or more QoE/RVQoE reports pertains to both QoE/RVQoE reports characterized by the UE AS, or to the QoE/RVQoE reports characterized by the UE application layer.

### UE Application Layer

In one embodiment, the UE application layer can receive a command from the UE AS comprising one or more filtering parameters and a request to return such filtering parameters in subsequent QoE/RVQoE reports.

The UE application layer, when assembling a QoE/RVQoE report, then determines whether the filtering parameters are to be associated with the QoE/RVQoE report. If so, the UE application layer adds one or more identifiers, flags, or tags to reflect the filtering parameters indicated in the command received from the UE AS, or according to the instruction received in a QMC configuration container transparently conveyed from the UE AS to the UE application layer in an AT command. The filtering parameters associated with the QoE report may be included within the container of the QoE report or it may be placed outside the QoE report, and in such case, added in an AT command and RRC signaling. For RVQoE report, the filtering parameters may be sent as separate IEs in the same way as other RVQoE parameters and therefore, added as parameters in AT command and RRC signaling.

In at least one embodiment, the UE application layer sends one or more QoE/RVQoE reports characterized according to the received filtering parameters to the UE AS. The filtering parameters may be included inside the QoE report container or attached outside the QoE report container.

Thus, according to the present disclosure, the UE performs the measurements according to the QoE measurement configuration. In some embodiments, the UE also considers the filtering parameters together with the QoE measurement configuration when performing the measurements. In other embodiments, however, the UE considers the filtering parameters after the measurements have been performed. In either case, though, the UE sends both a QoE report and characterizing information associated with the QoE report to the RAN node. In this disclosure, the characterizing information sent to the RAN node is based on the one or more filtering parameters associated with the received QoE measurement configuration.

### Filtering Parameters to Characterize QoE/RVQoE Reports

The filtering parameters that characterize QoE/RVQoE reports may comprise one or more of the following:
UE speed/velocity.
RAT in use (e.g., the Area Scope may be restricted based on the RAT used in the cell or the RAT the concerned UE is using.)
Support of 5GC (5G Core).
Support for HSDN in the cells.
Support for CSG in the cells.
Support for SNPN networks in the cells (NPN-Identity).
Support for PNI-NPN networks in the cells (CAG cells).
Support of PWS in the cells (Public Warning System).
Support of Sidelink in the cells
UE's support for MR-DC
PLMN identity.
Cells served by IAB-nodes and/or mobile IAB nodes.
Network slice, or part thereof (e.g., only the SST part of the S-NSSAI).
Multicast Service/Broadcast Service/MBS/MBMS support in the cells
Geographical Area Scope definition or filter criterion/criteria.
NB-IoT support in the cells.
Licensed Assisted Access (LAA) in the cells.
2-step RACH in the cells
Shared/unlicensed spectrum (NR-U).
Non-Terrestrial Network (NTN) support in the cells
Small data transmissions.
Support for resource coordination and interference mitigation in the cells.
Area Scope combined with a speed condition Connectivity mode.
Whether the session was carried by the MCG, the SCG or both the MCG and the SCG.
Whether the RVQoE configuration was generated by MN or SN.
UE state, such as RRC_CONNECTED, RRC_INACTIVE, RRC_IDLE
UE's preferred RRC state (as indicated by preferredRRC-State)
UE's mobility history.
Duplex mode, FDD or TDD.
Condition on other features, e.g., that MDT is also configured in the cell.
Indication of QoE data collection applicability broadcast in each cell
Area Scope definitions including logical expressions
Combinations of existing Area Scope definition means/possibilities
Service type of another application session that should be going on in parallel in order for the filter condition to be fulfilled.
Whether certain application was used for the session
UE brand (e.g., vendor or manufacturer)
UE brand (e.g., vendor or manufacturer) and model
Conditional QoE/RVQoE configuration
Application identifier(s) (narrowing down the service type to specific application(s))
Operation in shared (unlicensed) spectrum
QoE triggered events or RVQoE triggered events
The filtering parameters listed above may originate from either the application layer in the UE or from the UE AS layer. Some parameters may also be attached by the gNB/CU before transmission to the MCE or to the DU.

According to the present disclosure, filtering could be done at different levels. Such levels include, for example, levels from fine filtering to coarse filtering, and may depend on the number of criteria that must be met. A report analyzing entity may be, for example, the RAN node that knows of the filtering parameters. In these cases, the RAN node could analyze the reports (e.g., the RVQoE reports) and filter the QoE/RVQoE reports accordingly after it receives the QoE/RVQoE reports. Further, according to the present embodiments, a report analysis could be prioritized based on the filtering levels, or according to the amount of reports that meet certain criterion/criteria (e.g., the largest group of reports meeting a certain criterion could be batch analyzed first, while groups of fewer reports could be down-prioritized).

Fine filtering may imply that multiple criteria must met at once, while coarse filtering may allow only a single criterion to be met. Additionally, fine filtering could be done based on the type of criteria, such as physical layer parameters, spectral parameters, etc. For course filtering, only a single criterion may be met (e.g., mobility history or RRC changes, or connectivity mode change history).

### Implicit Indication of Filters Applied to the Content of QoE/RVQoE Reports

As an alternative to the previously described embodiments that explicitly indicate the filters applied in a QoE/RVQoE report or associated with a QoE/RVQoE report, one embodiment uses implicit indications.

In the case of a RVQoE report, the multiple receivers may, for example, be a MN and a SN, which are interested in different types of RVQoE metrics, or RVQoE metrics collected under different circumstances. In such cases, both of these aspects could be controlled through filter parameter(s) in the RVQoE configuration(s) and/or associated with the RVQoE configuration(s). In this case, the UE could compile RVQoE reports according to each of the filter configurations and send the RVQoE reports compiled based on the filter parameter(s) associated with the MN to the MN (without any explicit filter indication included in or associated with the RVQoE report). Similarly, the UE could send the RVQoE reports compiled based on the filter parameter(s) associated with the SN to the SN without any explicit filter indication included in or associated with the RVQoE report. Each receiver, i.e., the MN or the SN in this case, will know, without having an explicit indication included in or associated with the received RVQoE report, that the received RVQoE report has been compiled based on the filter parameter(s) associated with the receiver.

In the case of a QoE report, the multiple receivers may be different MCEs or possibly other entities in the OAM system, such as consumers of QoE reports (e.g., the Network Data Analytics Function (NWDAF)), or other RAN external entities. In this case, the UE may associate an indication of the applied filter(s) with the QoE report. This association may be done either by the UE application layer or by the UE AS. The UE sends the QoE report and the associated filter indication to the RAN, and the RAN forwards the QoE report to the intended receiver without the associated filter indication. The RAN may determine the intended receiver based on the filter indication associated with the QoE report received from the UE, or based on another parameter received together with the QoE report, e.g., a measConfigAppLayerId-r17 parameter, an indication of the receiving entity, or another explicit indication or identifier. The entity receiving the QoE report forwarded by the RAN then knows that the QoE report has been compiled based on the filter parameter(s) associated with the receiving entity.

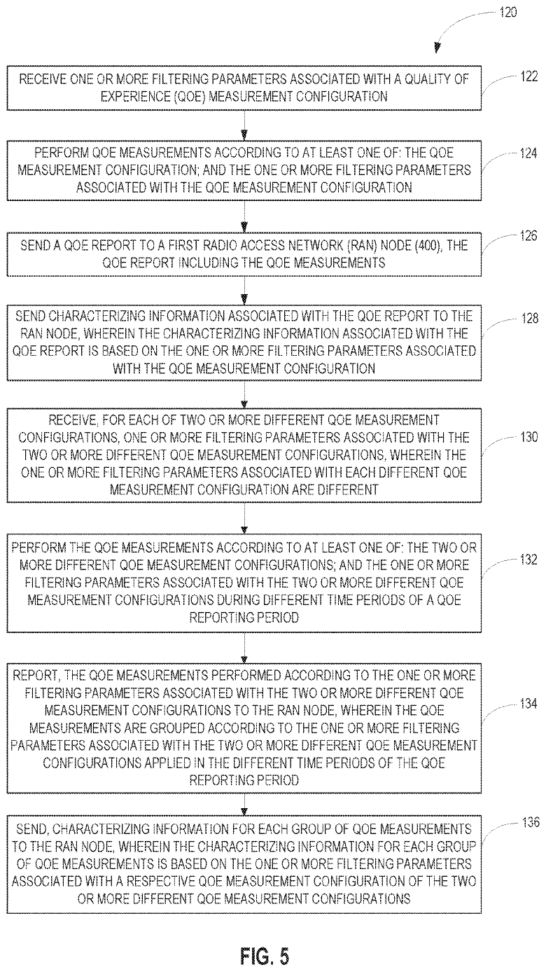

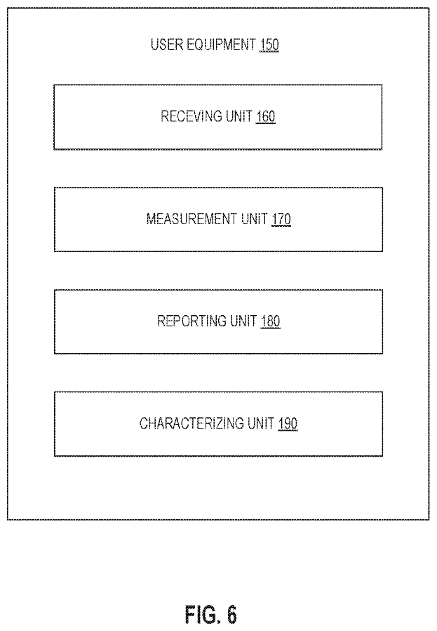

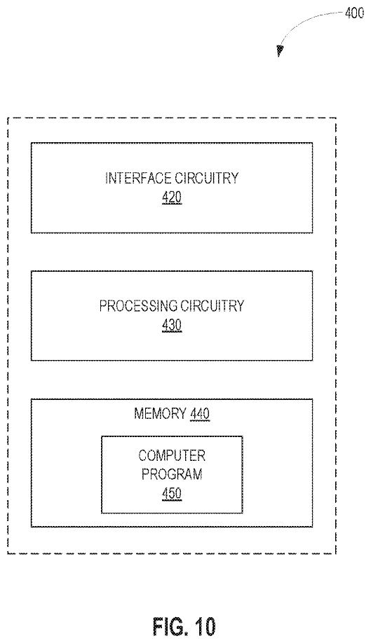

FIG. 5 illustrates a method 120 implemented by a UE 150 (shown in FIG. 6). As seen in method 120, the UE 150 receives one or more filtering parameters associated with a Quality of Experience (QoE) measurement configuration (block 122). The UE 150 then performs QoE measurements according to at least one of the QoE measurement configuration and the one or more filtering parameters associated with the QoE measurement configuration (block 124) and sends a QoE report to a first radio access network (RAN) node 400 (shown in FIG. 10) (box 126). In this embodiment, the QoE report includes the QoE measurements. The UE 150 further sends characterizing information associated with the QoE report to the first RAN node. In this embodiment, the characterizing information associated with the QoE report is based on the one or more filtering parameters associated with the QoE measurement configuration (block 128).

In one aspect of the present disclosure, UE 150 further receives, for each of two or more different QoE measurement configurations, one or more filtering parameters associated with the two or more different QoE measurement configurations (box 130). In this aspect, the one or more filtering parameters associated with each different QoE measurement configuration are different from each other. So received, UE 150 performs the QoE measurements according to at least one of the two or more different QoE measurement configurations and the one or more filtering parameters associated with the two or more different QoE measurement configurations. In this embodiment, the measurements are performed during different time periods of a QoE reporting period (box 132). The UE then reports the QoE measurements performed according to the one or more filtering parameters associated with the two or more different QoE measurement configurations to the RAN node (box 134). In this aspect, the QoE measurements are grouped according to the one or more filtering parameters associated with the two or more different QoE measurement configurations applied in the different time periods of the QoE reporting period. UE 150 also sends, to the RAN node, characterizing information for each group of QoE measurements to the RAN node. In this embodiment, the characterizing information for each group of QoE measurements is based on the one or more filtering parameters associated with a respective QoE measurement configuration of the two or more different QoE measurement configurations (box 136).

In one embodiment, the one or more filtering parameters are not visible to the first RAN node.

In another embodiment, however, the one or more filtering parameters are visible to the first RAN node.

In one embodiment, the one or more filtering parameters are received as part of the QoE measurement configuration.

In one embodiment, the characterizing information associated with the QoE report indicates the one or more filtering parameters that were applied when performing the QoE measurements.

In one embodiment, reporting the QoE measurements grouped according to the one or more filtering parameters applied in the different time periods comprises sending a separate QoE report for each time period.

In one embodiment, the characterizing information associated with the QoE report indicates the one or more filtering parameters associated with the two or more different QoE measurement configurations that were applied when performing the QoE measurements.

In one embodiment, sending the characterizing information associated with the QoE report to the RAN node comprises sending the characterizing information as part of the QoE report. In another embodiment, however, sending characterizing information associated with the QoE report to the RAN node comprises sending the characterizing information separately from the QoE report.

FIG. 6 illustrates an exemplary UE 150 configured for measurement reporting as herein described. As seen in the embodiment of FIG. 6, UE 150 comprises a receiving unit 160, a measurement unit 170, a report unit 180, and a characterizing unit 190. The various units 160-190 can be implemented by hardware and/or by software executed by one or more microprocessors. The receiving unit 160 is configured to receive one or more filtering parameters associated with a Quality of Experience (QoE) measurement configuration, as previously described. The measurement unit 170 is configured to perform QoE measurements according to at least one of the QoE measurement configuration and the one or more filtering parameters associated with the QoE measurement configuration, as previously described. The reporting unit 180 is configured to send a QoE report including the QoE measurements to a first Radio Access Network (RAN) node, as previously described. The characterizing unit 190 is configured to send characterizing information associated with the QoE report to the RAN node. In this embodiment, the characterizing information associated with the QoE report is based on the one or more filtering parameters associated with the QoE measurement configuration, as previously described.

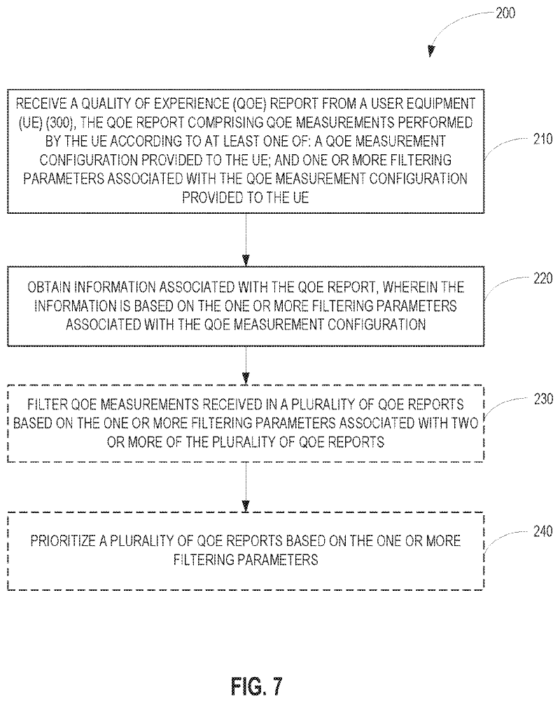

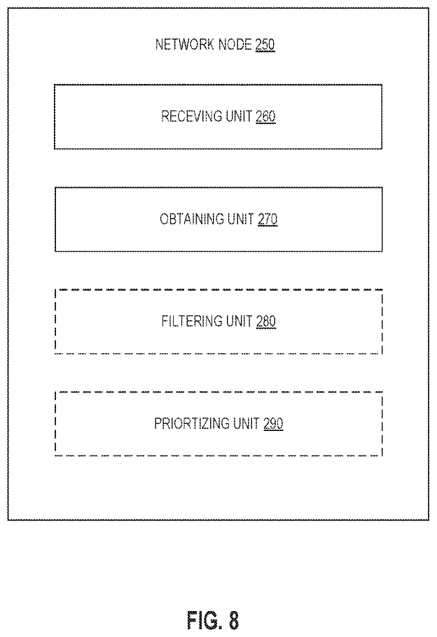

FIG. 7 illustrates a method 200 implemented by a network node, such as the network node 250 shown in FIG. 8. As seen in FIG. 7, network node 250 receives a Quality of Experience (QoE) report from a U, such as UE 150 (box 210). In this aspect, the QoE report comprises QoE measurements performed by UE 150 according to at least one of a QoE measurement configuration provided to the UE and one or more filtering parameters associated with the QoE measurement configuration provided to the UE. The network node 250 also obtains information associated with the QoE report. The information, in this embodiment, is based on the one or more filtering parameters associated with the QoE measurement configuration (block 220). The network node 250 may optionally filter the QoE measurements received in a plurality of QoE reports based on the one or more filtering parameters associated with two or more of the plurality of QoE reports (block 230) or prioritize a plurality of QoE reports based on the one or more filtering parameters (block 240).

In one embodiment, the one or more filtering parameters are not visible to a Radio Access Network (RAN) node serving the UE.

In another embodiment, the one or more filtering parameters are visible to a RAN node serving the UE.

In one embodiment, obtaining information associated with the QoE report comprises receiving, from the UE, characterizing information associated with the QoE report.

In one embodiment, the characterizing information is indicative of the one or more filtering parameters applied by the UE when the QoE measurements were performed by the UE.

In another embodiment, however, obtaining information associated with the QoE report comprises determining characterizing information associated with the QoE report based on a type of the network node.

In one embodiment, receiving, from the UE, characterizing information associated with the QoE report comprises receiving the characterizing information as part of the QoE report.

In another embodiment, receiving, from the UE, characterizing information associated with the QoE report comprises receiving the characterizing information separately from the QoE report.

In one embodiment, method 200 further comprises the network node filtering QoE measurements received in a plurality of QoE reports based on the one or more filtering parameters associated with two or more of the plurality of QoE reports.

In one embodiment, method 200 further prioritizes a plurality of QoE reports based on the one or more filtering parameters.

In one embodiment, method 200 of FIG. 7 is performed by a RAN node, such as RAN node 400 seen in FIG. 10.

In another embodiment, method 200 of FIG. 7 is performed by a measurement collection node.

FIG. 8 illustrates an exemplary network node 250 configured for measurement reporting as herein described. As seen in FIG. 8, network node 250 comprises a receiving unit 260, an obtaining unit 270, an optional filtering unit 280, and an optional prioritizing unit 290. The various units 260-290 can be implemented by hardware and/or by software executed by one or more microprocessors.

In this aspect, the receiving unit 260 is configured to receive a Quality of Experience (QoE) report from a UE 150. As previously described, the QoE report comprises QoE measurements performed by UE 150 according to at least one of a QoE measurement configuration provided to the UE 150 and one or more filtering parameters associated with the QoE measurement configuration provided to the UE 150. The obtaining unit 270 is configured to obtain information associated with the QoE report. In one embodiment, the information is based on the one or more filtering parameters associated with the QoE measurement configuration. The optional filtering unit 280 is configured to filter QoE measurements received in a plurality of QoE reports based on the one or more filtering parameters associated with two or more of the plurality of QoE reports. The optional prioritizing unit 290 is configured to prioritize a plurality of QoE reports based on the one or more filtering parameters.

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessors or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

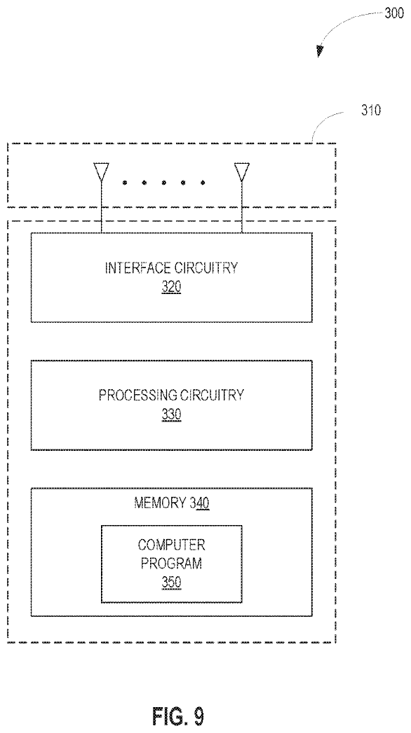

FIG. 9 shows the main functional components of a UE 300 configured for measurement reporting as herein described. As seen in FIG. 9, this embodiment of UE 300 comprises interface circuitry 320 coupled to one or more antennas 310, processing circuitry 330, and memory 340. The interface circuitry 320 comprises a radiofrequency (RF) enabling communication with network node 250 (e.g., RAN node 400 of FIG. 10). The RF circuitry may comprise a transceiver configured to operate according to the 5th Generation (5G) standard or other wireless communication standard now known or later developed.

The processing circuitry 330 comprises one or more microprocessors, hardware, firmware, or a combination thereof that controls the overall operation of the UE 300. The processing circuitry 330 can be configured by software to perform the method 120 of FIG. 5, as herein described.

Memory 340 comprises both volatile and non-volatile memory for storing computer program code and data needed by the processing circuitry 330 for operation. Memory 340 may comprise any tangible, non-transitory computer-readable storage medium for storing data including electronic, magnetic, optical, electromagnetic, or semiconductor data storage. Memory 340 stores a computer program 350 comprising executable instructions that configure the processing circuitry 330 in UE 300 to perform the method 120 of FIG. 5, as herein described. A computer program 350 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 350 for configuring the processing circuitry 330 as herein described may be stored in a removable memory, such as a portable compact disc, portable digital video disc, or other removable media. The computer program 350 may also be embodied in a carrier such as an electronic signal, optical signal, radio signal, or computer readable storage medium.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprise instructions that, when executed by a processor of a UE 300, cause the UE 300 to perform method 120 of FIG. 5, as described above.

Embodiments further include a computer program product comprising program code portions for performing the steps of any of the embodiments herein when the computer program product is executed by a computing device. This computer program product may be stored on a computer readable recording medium.

FIG. 10 shows the main functional components of a network node 400 configured for measurement reporting as herein described. The network node 400 may comprise a RAN node or a core network node. As seen in FIG. 10, network node 400 comprises interface circuitry 420, processing circuitry 430, and memory 440. The interface circuitry 420 comprises network interface circuitry enabling communication with other network nodes, core network nodes, UEs, such as UE 300, and or external systems over a communication network. The processing circuitry 430 comprises one or more microprocessors, hardware, firmware, or a combination thereof that control the overall operation of the network node 400. Accordingly, the processing circuitry 430 can be configured by software to perform the method 200 of FIG. 7, as herein described.

Memory 440 comprises both volatile and non-volatile memory for storing computer program code and data needed by the processing circuitry 430 for operation. Memory 440 may comprise any tangible, non-transitory computer-readable storage medium for storing data including electronic, magnetic, optical, electromagnetic, or semiconductor data storage. Memory 440 is further configured to store a computer program 450 comprising executable instructions that configure the processing circuitry 430 in the network node 400 to perform the method 200 of FIG. 7, as herein described. A computer program 450 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 450 for configuring the processing circuitry 430 as herein described may be stored in a removable memory, such as a portable compact disc, portable digital video disc, or other removable media. The computer program 450 may also be embodied in a carrier such as an electronic signal, optical signal, radio signal, or computer readable storage medium.

Those skilled in the art will also appreciate that embodiments herein further include one or more computer programs, such as corresponding computer program 450. A computer program 450 comprises instructions which, when executed on at least one processor of an apparatus, cause the apparatus to carry out any of the respective processing described above. A computer program 450 in this regard may comprise one or more code modules corresponding to the means or units described above.

Embodiments of the present disclosure further include a carrier containing such a computer program 450. This carrier may comprise one of an electronic signal, optical signal, radio signal, or computer readable storage medium.

Embodiments herein also include a computer program product stored on a non-transitory computer readable (storage or recording) medium and comprising instructions that, when executed by a processor of a network node 400, causes the network node 400 to perform as described above.

Embodiments further include a computer program product comprising program code portions for performing the steps of any of the embodiments herein when the computer program product is executed by a computing device. This computer program product may be stored on a computer readable recording medium.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are neither limited to the processing circuitry alone, nor to the other components of the computing device. Rather, they are enjoyed by the computing device as a whole, and/or by end users and a wireless network generally.

The present embodiments may, of course, be carried out in other ways than those specifically set forth herein without departing from characteristics described herein. The present embodiments are therefore to be considered in all respects as illustrative and not restrictive, and all changes coming within the meaning and equivalency range of the appended claims are intended to be embraced therein.

1-37. (canceled)

38. A method of measurement reporting implemented by a User Equipment (UE), the method comprising:
receiving one or more filtering parameters associated with a Quality of Experience (QoE) measurement configuration;
performing QoE measurements according to at least one of:
the QoE measurement configuration; and
the one or more filtering parameters associated with the QoE measurement configuration;
sending a QoE report to a first radio access network (RAN) node, the QoE report including the QoE measurements; and
sending characterizing information associated with the QoE report to the RAN node, wherein the characterizing information associated with the QoE report is based on the one or more filtering parameters associated with the QoE measurement configuration.

39. The method of claim 38, wherein the one or more filtering parameters are not visible to the first RAN node.

40. The method of claim 38, wherein the one or more filtering parameters are visible to the first RAN node.

41. The method of claim 38, wherein the one or more filtering parameters are received as part of the QoE measurement configuration.

42. The method of claim 38, wherein the characterizing information associated with the QoE report indicates the one or more filtering parameters that were applied when performing the QoE measurements.

43. The method of claim 38, further comprising receiving, for each of two or more different QoE measurement configurations, one or more filtering parameters associated with the two or more different QoE measurement configurations, wherein the one or more filtering parameters associated with each different QoE measurement configuration are different.

44. The method of claim 43, further comprising:
performing the QoE measurements according to at least one of:
the two or more different QoE measurement configurations; and
the one or more filtering parameters associated with the two or more different QoE measurement configurations during different time periods of a QoE reporting period;
reporting the QoE measurements performed according to the one or more filtering parameters associated with the two or more different QoE measurement configurations to the RAN node, wherein the QoE measurements are grouped according to the one or more filtering parameters associated with the two or more different QoE measurement configurations applied in the different time periods of the QoE reporting period; and
sending characterizing information for each group of QoE measurements to the RAN node, wherein the characterizing information for each group of QoE measurements is based on the one or more filtering parameters associated with a respective QoE measurement configuration of the two or more different QoE measurement configurations; and
wherein reporting the QoE measurements grouped according to the one or more filtering parameters applied in the different time periods comprises sending a separate QoE report for each time period.

45. The method of claim 43, wherein the characterizing information associated with the QoE report indicates the one or more filtering parameters associated with the two or more different QoE measurement configurations that were applied when performing the QoE measurements.

46. The method of claim 38, wherein sending the characterizing information associated with the QoE report to the RAN node comprises sending the characterizing information as part of the QoE report.

47. The method of claim 38, wherein sending the characterizing information associated with the QoE report to the RAN node comprises sending the characterizing information separately from the QoE report.

48. A User Equipment (UE) configured for measurement reporting, the comprising:
interface circuitry for communicating with a network node over a wireless communication channel; and
processing circuitry operatively connected with the interface circuitry, the processing circuitry being configured to:
receive one or more filtering parameters associated with a Quality of Experience (QoE) measurement configuration;
perform QoE measurements according to at least one of:
the QoE measurement configuration; and
the one or more filtering parameters associated with the QoE measurement configuration;
send a QoE report to a first Radio Access Network (RAN) node, the QoE report including the QoE measurements; and
send characterizing information associated with the QoE report to the RAN node, wherein the characterizing information associated with the QoE report is based on the one or more filtering parameters associated with the QoE measurement configuration.

49. A method of measurement reporting implemented by a network node, the method comprising:
receiving a Quality of Experience (QoE) report from a User Equipment (UE), the QoE report comprising QoE measurements performed by the UE according to at least one of:
a QoE measurement configuration provided to the UE; and
one or more filtering parameters associated with the QoE measurement configuration provided to the UE; and
obtaining information associated with the QoE report, wherein the information is based on the one or more filtering parameters associated with the QoE measurement configuration.

50. The method of claim 49, wherein obtaining information associated with the QoE report comprises determining characterizing information associated with the QoE report based on a type of the network node.

51. The method of claim 49, wherein obtaining information associated with the QoE report comprises receiving, from the UE, characterizing information associated with the QoE report.

52. The method of claim 51, wherein the characterizing information is indicative of the one or more filtering parameters applied by the UE when the QoE measurements were performed by the UE.

53. The method of claim 51, wherein receiving, from the UE, characterizing information associated with the QoE report comprises receiving the characterizing information as part of the QoE report.

54. The method of claim 51, wherein receiving, from the UE, characterizing information associated with the QoE report comprises receiving the characterizing information separately from the QoE report.

55. The method of claim 49, further comprising filtering QoE measurements received in a plurality of QoE reports based on the one or more filtering parameters associated with two or more of the plurality of QoE reports.

56. The method of claim 49, further comprising prioritizing a plurality of QoE reports based on the one or more filtering parameters.

57. A network node in a wireless communication network configured for measurement reporting, the network node comprising:
interface circuitry for communicating with other network nodes and/or User Equipment (UE); and
processing circuitry operatively connected to the interface circuitry, the processing circuitry being configured to:
receive a Quality of Experience (QoE) report from a User Equipment (UE), the QoE report comprising QoE measurements performed by the UE according to at least one of:
a QoE measurement configuration provided to the UE; and
one or more filtering parameters associated with a QoE measurement configuration; and
obtain information associated with the QoE report, wherein the information is based on the one or more filtering parameters associated with the QoE measurement configuration.
